(19) United States
(12) Patent Application Publication
(10) Pub. No.: US 2001/0047432 A1
(43) Pub. Date: Nov. 29, 2001

(54) Distributed command of a satellite location

(76) Inventor: Zvi David, Kfar Saba (IL)

Correspondence Address: DR. D. GRAESER LTD., C/O THE POLKINGHORNS, 9003 FLORIN WAY, UPPER MARLBORO, MD, 20772, US

(21) Appl. No.: 09/820,848

(22) Filed: Mar. 30, 2001

Related U.S. Application Data
(60) Provisional application No. 60/194,012, filed on Apr. 3, 2000.

(51) Int. Cl. G06F 15/16

(52) U.S. Cl. 709/249; 709/218

(57) ABSTRACT

A system and a method for enabling communication between a remote ground transceiver and a satellite to be controlled through a distributed network such as the Internet. It should be noted that “control” also includes monitoring such communication. The user is optionally and preferably able to control communication through a Web browser as an interface. The Web browser is connected to a Web server, which in turn is in communication with the satellite. Optionally, the Web server is able to communicate with the satellite through a ground station, although alternatively, communication is performed through a particular implementation of a ground transceiver. The present invention has a number of potential uses, such as for security systems for movable objects, such as automobiles for example; management of a fleet of powered devices, such as ships, automobiles, trucks, motorcycles, bicycles and/or trains for example; and for telemetry applications, such as for remote asset command and control for example. Examples of such telemetry applications include, but are not limited to, oil or gas pipelines, remote storage tanks or buildings, and home security applications.

This Application claims priority from U.S. Provisional Application No. 60/194,012, filed on Apr. 3, 2000, which is currently pending and which is incorporated by reference as if fully set forth herein.

### FIELD AND BACKGROUND OF THE INVENTION

The present invention is of a method and a system for distributed command of a satellite location system, and more specifically, for such a method and system for controlling the communication between a ground transceiver and a satellite through a distributed network such as the Internet.

Automated technology has enabled equipment which is located in remote areas to be managed at a management station. Such automated technology includes sensors for detecting equipment malfunctions, security mechanisms against theft, and other monitoring devices for ensuring the proper function of the equipment without the presence of a human operator. These monitoring devices must be able to relay their findings to a management station, particularly in the case of an equipment malfunction such that an alarm would be required. Transceivers which are based on a communication through a satellite is often the best or even the only choice for enabling the remote equipment to communicate with the management station.

Such transceivers operate through wireless communication with the satellite, which then relays the communication to the intended recipient, such as the management system. However, currently available management systems require the creation of a command and control center. This center may be expensive to create and maintain, such that a user with only a few remote devices to manage may find such an expense excessive. Thus, currently available management systems cannot accommodate a user who wishes to communicate with the remote device without such a command and control center.

A number of different systems and devices have been proposed for communication between a satellite and a ground device. For example, U.S. Pat. No. 5,664,006, incorporated by reference as if fully set forth herein, describes a system for connecting a user terminal device to a satellite and thence to a gateway. The gateway is then connected to a PSTN (public switched telephone network). As an additional example, U.S. Pat. No. 5,678,175, also incorporated by reference as if fully set forth herein, describes a system for communication with a plurality of satellites. Both of these examples contained detailed information about the frequency spectrum for communication between a ground transceiver and a low earth orbit satellite, orbiting at for example a 1414 km low earth orbit. However, neither example teaches or discloses a system for enabling a user to communicate with a ground device through a satellite, but without a command and control center, or other fixed location for communicating with the satellite.

There is therefore a need for, and it would be useful to have, a system and a method for communicating with a ground device through a satellite, without a command and control center, or other fixed location for such communication, such that the user could interact with the satellite from substantially any location in a flexible manner.

### SUMMARY OF THE INVENTION

The method and system of the present invention enable communication between a remote ground transceiver and a satellite to be controlled through a distributed network such as the Internet. It should be noted that “control” also includes monitoring such communication. The user is optionally and preferably able to control communication through a Web browser as an interface. The Web browser is connected to a Web server, which in turn is connected either to a ground station or to a ground transceiver. The ground station or ground transceiver is then in communication with the satellite. The present invention has a number of potential uses, such as for security systems for movable objects, such as automobiles for example; management of a fleet of powered devices, such as ships, automobiles, trucks, motorcycles, bicycles and/or trains for example; and for telemetry applications, such as for remote asset command and control for example. Examples of such telemetry applications include, but are not limited to, oil or gas pipelines, remote storage tanks or buildings, and home security applications.

According to the present invention, there is provided a system for controlling communication with a satellite at a remote location through a network, comprising: (a) a ground station for receiving communication from, and transmitting communication to, the satellite; and (b) a communication server connected to the network for receiving communication from, and transmitting communication to, the remote location, said communication server being in communication with said ground station.

According to another embodiment of the present invention, there is provided a method for controlling communication with a satellite at a remote location through a network, the method comprising the steps of: (a) receiving a communication from the satellite; (b) translating said communication into a network communication protocol for transmission on the network to form a translated communication; and (c) sending said translated communication to the remote location through the network.

Hereinafter, the term “computing platform” refers to a computer hardware system or to a software operating system, and more preferably refers to a combination of computer hardware and the software operating system which is run by that hardware. Examples of particularly preferred computing platforms include, but are not limited to, embedded systems such as devices operated by Windows CE™ (Microsoft Corp., USA) or DXworks™, as well as any embedded operating systems suitable for use with a satellite or other communications product.

For the implementation of the present invention, a software application could be written in substantially any suitable programming language, which could easily be selected by one of ordinary skill in the art. The programming language chosen should be compatible with the computing platform according to which the software application is executed. Examples of suitable programming languages include, but are not limited to, C, C++ and Java.

In addition, the present invention could also be implemented as firmware or hardware. Hereinafter, the term “firmware” is defined as any combination of software and hardware, such as software instructions permanently burnt onto a ROM (read-only memory) device. As hardware, the present invention could be implemented as substantially any type of chip or other electronic device capable of performing the functions described herein.

In any case, the present invention can be described as a plurality of instructions being executed by a data processor, in which the data processor is understood to be implemented according to whether the present invention is implemented as software, hardware or firmware.

### BRIEF DESCRIPTION OF THE DRAWINGS

The invention is herein described, by way of example only, with reference to the accompanying drawings, wherein:

FIG. 1 is a schematic block diagram showing an exemplary system according to the present invention;

FIG. 2 is a schematic block diagram showing an exemplary remote asset transceiver for use with the present invention; and

FIG. 3 is a flowchart of an exemplary method according to the present invention.

### DESCRIPTION OF THE PREFERRED EMBODIMENTS

The method and system of the present invention enable communication between a remote ground transceiver and a satellite to be controlled through a distributed network such as the Internet. It should be noted that “control” also includes monitoring such communication. The user is optionally and preferably able to control communication through a Web browser as an interface. The Web browser is connected to a Web server, which in turn is in communication with the satellite. Optionally, the Web server is able to communicate with the satellite through a ground station, although alternatively, communication is performed through a particular implementation of a ground transceiver. The present invention has a number of potential uses, such as for security systems for movable objects, such as automobiles for example; management of a fleet of powered devices, such as ships, automobiles, trucks, motorcycles, bicycles and/or trains for example; and for telemetry applications, such as for remote asset command and control for example. Examples of such telemetry applications include, but are not limited to, oil or gas pipelines, remote storage tanks or buildings, and home security applications.

The principles and operation of a method and a system according to the present invention may be better understood with reference to the drawings and the accompanying description.

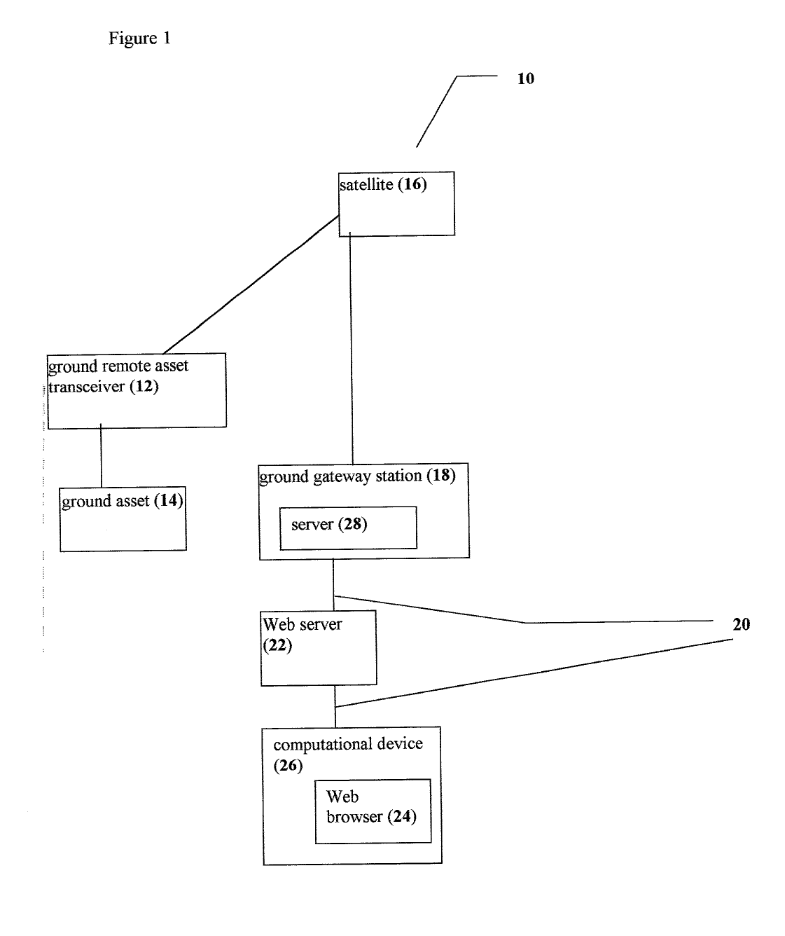

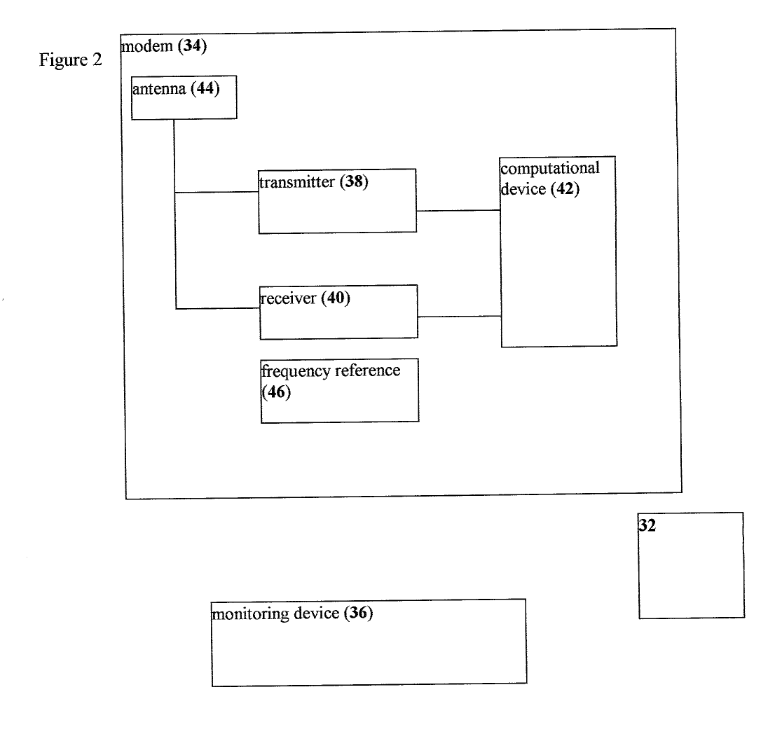

Referring now to the drawings, FIG. 1 shows a system 10 according to the present invention for communication between a ground asset and a Web browser operated by the user. System 10 features a ground remote asset transceiver 12 which is connected to a ground asset 14. Ground remote asset transceiver 12 is optionally and preferably constructed according to the illustration of FIG. 2. Ground remote asset transceiver 12 is in communication with a satellite 16, which is preferably in low earth orbit. Satellite 16 receives a communication from a ground remote asset transceiver 12 when ground remote asset transceiver 12 is within the “footprint” of satellite 16.

For example, ground remote asset transceiver 12 could attempt to contact satellite 16 to request a channel. Ground remote asset transceiver 12 could be any device which is capable of receiving and transmitting signals in the correct frequency spectrum, such as any device which features a RF modem for example, although ground remote asset transceiver 12 is implemented as described with regard to FIG. 2 below. The channel between ground remote asset transceiver 12 and satellite 16 is preferably determined according to a Time Division Multiple Access (TDMA) protocol, such that ground remote asset transceiver 12 would request a time slot for transmitting to satellite 16. However, the initial request from ground remote asset transceiver 12 is preferably sent according to a random access ALOHA protocol, which is an example of a contention protocol (for a description of ALOHA and its variants, see Tanenbaum A. S., Computer Networks, Prentice-Hall, 1996, pp. 121-124 for example).

Once satellite 16 receives the request, assuming that a collision does not occur between this request message and such a message from a different ground remote asset transceiver 12, satellite 16 assigns a particular time slot to ground remote asset transceiver 12. Ground remote asset transceiver 12 then transmits data to satellite 16. Satellite 16 then passes this communication to a ground gateway station 18 when ground gateway station 18 is within the “footprint” of satellite 16. Ground gateway station 18 also features a suitable transceiver device for receiving signals in the desired frequency range, such as a RF modem for example. Preferably, satellite 16 and ground gateway station 18 communicate according to a TDMA (Time Division Multiple Access) protocol, although other communication protocols could be used as is well known in the art, such as the CDMA (Code Division Multiple Access) protocol.

As its name suggests, ground gateway station 18 is a gateway for these messages from satellite 16 to the ground, and is connected to a ground communication network 20, which could be the Internet for example. For system 10 according to the present invention, ground gateway station 18 passes the communication to a Web server 22 through ground communication network 20. The user can then interact with satellite 16, and hence with ground asset 14, through a Web browser 24 being operated by a computational device 26 which is connected to ground communication network 20.

Web server 22 optionally and preferably interacts with ground gateway station 18 as follows. Ground gateway station 18 is connected to Web server 22 through ground communication network 20, which is preferably a dedicated WAN (wide area network) or other dedicated network for this connection. Such a connection could optionally be implemented as a dedicated telephone data circuit, an ISDN connection (integrated system digital network), or microwave circuit, for example. The suitable transceiver device of ground gateway station 18 (not shown; see FIG. 2) receives the signals from satellite 16. These signals are then processed, for example as described in U.S. Pat. Nos. 5,664,006 and 5,678,175, incorporated by reference as if fully set forth herein. Ground gateway station 18 also contains suitable equipment for connection to ground communication network 20 (not shown), such as a router for example. Preferably, the communication protocol format used by ground gateway station 18 is a standard format, such as the X.400 standard of the ITU (International Telecommunications Union).

More preferably, ground gateway station 18 also includes a server 28 which is capable of communicating according to the HTTP protocol. Alternatively, Web server 22 could replace server 28, such that Web server 22 would be located within ground gateway station 18. The signals which ground gateway station 18 receives from satellite 16 are therefore more preferably translated into HTTP data, which is transmitted from server 28 to Web server 22. Such a translation process optionally and preferably includes the steps of preparing a Web page from the received data.

Preferably, the user is also able to enter commands and/or instructions to ground asset 14 through Web browser 24, for example through a form served by Web server 22. For example, the user could request the current status and/or location of ground asset 14. The commands and/or instructions would then be received by ground gateway station 18, and translated into a format which is suitable for transmission to ground asset 14 through satellite 16.

In addition, ground gateway station 18 also optionally performs authentication of Web server 22. However, Web server 22 preferably authenticates the user of Web browser 24, for example by requiring the user to enter a password or other identifier, such as a biometric measurement for example. An example of a biometric measurement is a fingerprint.

It should be noted that Web server 22 is an example of a communication server according to the present invention. Such a communication server could communicate with the user at the remote location through substantially any suitable network communication protocol, including but not limited to, HTTP and/or an e-mail protocol such as IMAP or SMTP for example. For communication through e-mail, Web browser 24 is optionally substituted by an e-mail software program, which could easily be selected from programs which are known in the art.

FIG. 2 is a schematic block diagram showing an exemplary ground remote asset transceiver according to a preferred embodiment of the present invention, implemented as part of the remote installation. As shown, a ground remote asset transceiver 32 features a RF modem 34, which could be a VHF modem for example. RF modem 34 is in communication with a monitoring device 36, preferably combined within the same housing as RF modem 34 to form a single unit. Monitoring device 36 monitors the function of at least one component of the remote installation (not shown). If a malfunction is detected, then monitoring device 36 sends a message to the central management station (not shown) through RF modem 34.

RF modem 34 could be implemented according to the modem disclosed in U.S. Pat. No. 5,666,648, for example, incorporated by reference as if fully set forth herein. In this implementation, RF modem 34 features a transceiver-satellite uplink transmitter 38, and a transceiver-satellite downlink receiver 40, for sending and receiving signals, respectively. Transceiver-satellite downlink receiver 40 receives the signals and downconverts, demodulates and decodes these signals. The received signals from transceiver-satellite downlink receiver 40 are processed by a computational device 42, which could be any of the previously disclosed computational platforms, for example. Computational device 42 optionally decrypts the message, for example.

In addition, computational device 42 also prepares the signal for transmission by transceiver-satellite uplink transmitter 38, for example optionally by encrypting the message. Transceiver-satellite uplink transmitter 38 then encodes and modulates the message from computational device 42, and then upconverts the signal to the channel frequency for transmission. Transceiver-satellite uplink transmitter 38 is connected to an antenna 44 for transmitting the data. Antenna 44 could be a normal-mode helix antenna such as those employed with portable VHF transceivers. All of the steps of processing of the signal itself which are performed by transceiver-satellite uplink transmitter 38 and transceiver-satellite downlink receiver 40 are performed with reference to a frequency reference 46.

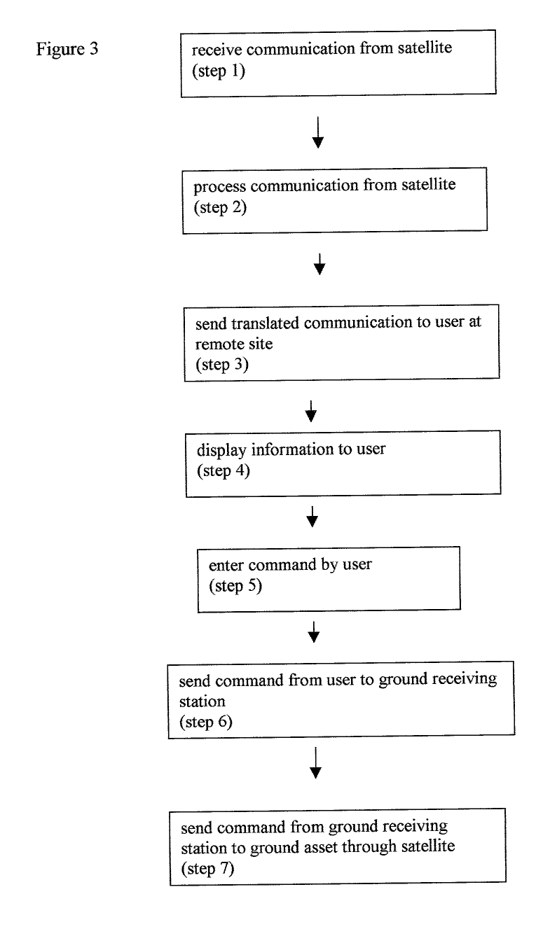

FIG. 3 is a flowchart of an exemplary method according to the present invention for communicating with a satellite through a network, such that the user can be at substantially any location to which the network is connected. For the purposes of explanation only and without any intention of being limiting, the network is assumed to be the Internet.

In step 1, a communication is received from the satellite by a suitable ground receiving station, such as the gateway of FIG. 1. In step 2, this ground receiving station processes the communication in order to translate the communication into a suitable network communication protocol format. For example, such a format could be HTTP. The communication from the satellite is preferably given in a particular format, such that certain types of data are contained within predefined data fields, for greater ease of translating the data.

In step 3, the translated communication is sent to the user at the remote location. For example, if the translated communication features HTTP data, then preferably the remote location is operating a Web browser, and the HTTP data is sent from the ground receiving station by a Web server. Preferably, the user would be required to “log onto” the Web server by entering a password, or other identifying information, before any data could be sent or received.

In step 4, the translated communication is displayed to the user, for example as a Web page. The data display may optionally include a textual message from the satellite. For example, if the user is communicating with a ground asset through the satellite, then the display may include information about the operation of the ground asset. Additionally, the display may include a map of the location of the ground asset, which is particularly useful for ground assets which are movable, such as various types of vehicles for example. Examples of different types of maps include, but are not limited to, scan map, vectorial map, air photo map and so forth.

Optionally and preferably, the user is also able to send commands and/or other instructions to the ground receiving station, and hence to the satellite, according to the suitable network communication protocol format. For example, the user could optionally enter such instructions through a form which is displayed by the Web browser in step 5. The resultant data would then be sent to the ground receiving station in step 6. The ground receiving station would then optionally and preferably pass the communication to the ground asset through the satellite in step 7. For example, the user could request the current operational status and/or location of the ground asset. The ground asset would then send a reply message to the user through the satellite as previously described.

It will be appreciated that the above descriptions are intended only to serve as examples, and that many other embodiments are possible within the spirit and the scope of the present invention.

What is claimed is:

1. A system for controlling communication with a satellite at a remote location through a network, comprising:
(a) a ground station for receiving communication from, and transmitting communication to, the satellite; and
(b) a communication server connected to the network for receiving communication from, and transmitting communication to, the remote location, said communication server being in communication with said ground station.

2. The system of claim 1, wherein said satellite is in a low earth orbit.

3. The system of claim 1, wherein the remote location is operating a Web browser, and said communication server is a Web server.

4. The system of claim 1, wherein the network is the Internet.

5. The system of claim 1, wherein the remote location is operating a e-mail software program, and said communication server is an e-mail server.

6. A method for controlling communication with a satellite at a remote location through a network, the method comprising the steps of:
(a) receiving a communication from the satellite;
(b) translating said communication into a network communication protocol for transmission on the network to form a translated communication; and
(c) sending said translated communication to the remote location through the network.

7. The method of claim 6, wherein said network communication protocol is HTTP, such that the remote location is operating a Web browser.

8. The method of claim 6, wherein said network communication protocol is an e-mail protocol, such that the remote location is operating an e-mail software program.

9. The method of claim 6, wherein the network is the Internet.
